(19) United States
(12) Patent Application Publication
(10) Pub. No.: US 2026/0155880 A1
(43) Pub. Date: Jun. 4, 2026

(54) APPARATUS AND METHOD FOR MOBILITY-AWARE RESOURCE MANAGEMENT BASED ON HIERARCHICAL OPEN-RAN ARCHITECTURE IN WIRELESS COMMUNICATION SYSTEM

(71) Applicant: ELECTRONICS AND TELECOMMUNICATIONS RESEARCH INSTITUTE, Daejeon (KR)

(72) Inventors: Min Hyun KIM, Daejeon (KR); Jung Mo MOON, Daejeon (KR); Jeong Ho KWAK, Daejeon (KR); Jong Won HAN, Daejeon (KR)

(21) Appl. No.: 19/402,440

(22) Filed: Nov. 26, 2025

(30) Foreign Application Priority Data
Nov. 29, 2024 (KR) 10-2024-0174735
Nov. 17, 2025 (KR) 10-2025-0173819

(51) Int. Cl. H04B 7/06; H04B 17/318; H04W 4/02

(52) U.S. Cl. CPC H04B 7/06952; H04B 17/328; H04W 4/025

(57) ABSTRACT

The present disclosure relates generally to a wireless communication system, and more particularly, to an apparatus and method for mobility-aware resource management based on a hierarchical Open-RAN architecture in a wireless communication system. An operation method of a base station according to the present invention includes: receiving, by an O-CU/DU, valid region information and transmission power information to be scheduled from a Near-RT-RIC; measuring reference signal received power of each GoB beam for users within the valid region; determining, for each user, a GoB beam tuple having the highest reference signal received power; determining user scheduling and GoB beam scheduling by selecting a tuple that maximizes a predefined objective function; and transmitting data based on the scheduling information.

### CROSS REFERENCE TO RELATED APPLICATIONS

This application claims priority to Korean Patent Application No. 10-2024-0174735, filed on Nov. 29, 2024, and Korean Patent Application No. 10-2025-0173819, filed on Nov. 17, 2025, the entire contents of which are hereby incorporated by reference.

### BACKGROUND OF THE INVENTION

### Field of the Invention

The present disclosure relates generally to a wireless communication system, and more particularly, to an apparatus and method for mobility-aware resource management based on a hierarchical Open-RAN architecture in a wireless communication system.

### Description of the Related Art

Open Radio Access Network (Open-RAN) is a structure that separates the existing Radio Access Network (RAN) into various functional components and interconnects them through open interfaces. Open-RAN is suitable for high-speed and low-latency environments of 5G (5th Generation) and 6G (6th Generation) networks, and is expected to further enhance the efficiency of network management through network control utilizing Artificial Intelligence (AI) and resource virtualization technology.

Network slicing, one of the core technologies of 5G Open-RAN, is a technology that divides a single physical network infrastructure into multiple virtual networks. Each slice can be customized to the requirements of a specific service or user group, and can have various network characteristics such as data transmission rate, delay time, and security level.

The existing static network slicing technology attempted to guarantee the network quality required for a specific service by fixedly dividing network resources in a predetermined manner. However, this approach has limitations in that it cannot reflect changes in dynamic channel environments or changes in inter-cell interference relationships that may occur as users move. In particular, when users move within a network, channel conditions and interference between adjacent cells continuously change and can affect network performance, so more flexible resource management that takes this into account is necessary.

Various technologies have been proposed to dynamically determine beam scheduling, user scheduling, transmission power, and bandwidth allocation to improve transmission performance, but most existing studies have proceeded in a manner of obtaining variables to be optimized under the assumption that specific control variables are determined in advance.

### SUMMARY OF THE INVENTION

Based on the above discussion, the present disclosure provides an apparatus and method for dynamically allocating resources by utilizing the hierarchical structure of an Open Radio Access Network (Open-RAN) network and user mobility information in a wireless communication system.

The present disclosure also provides an apparatus and method for dynamically determining GoB (Grid of Beams) beam scheduling (including predefined codebook-based beam scheduling), user scheduling, transmission power, and bandwidth allocation based on user mobility information, interference relationships, and channel conditions in a wireless communication system.

The present disclosure also provides an apparatus and method for maximizing the utility sum of data transmission rates while satisfying quality of service requirements by utilizing Lyapunov optimization techniques in a wireless communication system.

The present disclosure also provides an apparatus and method for effectively optimizing resources while reducing computational complexity by decomposing into inter-slice and intra-slice problems according to time scales in a wireless communication system.

The present disclosure also provides an apparatus and method for determining valid region selection and power allocation for each base station at a Near-RT (Near Real-Time) time scale by applying deep reinforcement learning in a wireless communication system.

According to various embodiments of the present disclosure, in a wireless communication system, an O-CU/DU (Open-Centralized Unit/Distributed Unit) of a base station for hierarchical Open-RAN architecture-based resource management receives valid region information and transmission power information to be scheduled from a Near-RT-RIC (Near Real-Time RAN Intelligent Controller), measures reference signal received power of each GoB (Grid of Beams) beam for users within the valid region, determines a GoB beam tuple having the highest reference signal received power for each user, determines user scheduling and GoB beam scheduling by selecting a tuple that maximizes a predefined objective function, and transmits data based on the scheduling information.

According to various embodiments of the present disclosure, in a wireless communication system, a Near-RT-RIC receives user mobility information at a Near-RT time scale from an external location information server, determines a valid region by mapping users to located regions using a region mapping module, receives average data transmission rate, virtual queue information, and interference information of users within a valid region combination for each base station from the O-CU/DU, uses a deep reinforcement learning agent to set the received information as a state, sets a predefined objective function reward, determines valid region selection and transmission power to be allocated for each base station as an action, and transmits the determined valid region information and transmission power information to the O-CU/DU.

According to various embodiments of the present disclosure, in a wireless communication system, a base station for hierarchical Open-RAN architecture-based resource management includes a transceiver and a processor, wherein the processor receives valid region information and transmission power information to be scheduled from a Near-RT-RIC, measures reference signal received power of each GoB beam for users within the valid region, determines a GoB beam tuple having the highest reference signal received power for each user, determines user scheduling and GoB beam scheduling by selecting a tuple that maximizes a predefined objective function, and transmits data based on the scheduling information.

According to various embodiments of the present disclosure, in a wireless communication system, a Near-RT-RIC apparatus includes a transceiver and a processor, wherein the processor receives user mobility information at a Near-RT time scale from an external location information server, determines a valid region by mapping users to located regions using a region mapping module, receives average data transmission rate, virtual queue information, and interference information of users within a valid region combination for each base station from the O-CU/DU, uses a deep reinforcement learning agent to set the received information as a state, sets a predefined objective function as a reward, determines valid region selection and transmission power to be allocated for each base station as an action, and transmits the determined valid region information and transmission power information to the O-CU/DU.

The apparatus and method according to various embodiments of the present disclosure can enable effective quality of service control by improving network transmission performance through dynamic resource management technology utilizing hierarchical structure and user mobility information in an Open-RAN network.

The apparatus and method according to various embodiments of the present disclosure can enable efficient use of limited network resources by dynamically allocating network resources according to user mobility and channel environment that change in real-time.

The apparatus and method according to various embodiments of the present disclosure can satisfy various quality of service requirements by guaranteeing the minimum data transmission rate required for each user.

The apparatus and method according to various embodiments of the present disclosure can reduce the high computational complexity occurring in the process of dynamically determining GOB (Grid of Beams) beam scheduling, user scheduling, transmission power, and bandwidth allocation by exchanging decision variables and feedback information at different time scales for each layer.

The effects obtainable from the present disclosure are not limited to the effects mentioned above, and other effects not mentioned will be clearly understood by those of ordinary skill in the art to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates the overall structure of a hierarchical Open-RAN architecture-based resource management system according to an embodiment of the present disclosure.

FIG. 2 illustrates an example of a valid region determination process through a region mapping module according to an embodiment of the present disclosure.

FIG. 3 is a flowchart illustrating an operation method of a base station (O-CU/DU) according to an embodiment of the present disclosure.

FIG. 4 is a flowchart illustrating an operation method of a Near-RT-RIC according to an embodiment of the present disclosure.

FIG. 5 is a block diagram illustrating the configuration of a wireless communication apparatus according to an embodiment of the present disclosure.

### DETAILED DESCRIPTION OF THE INVENTION

Terms used in the present disclosure are used only to describe specific embodiments and may not be intended to limit the scope of other embodiments. Singular expressions may include plural expressions unless the context clearly dictates otherwise. Technical or scientific terms used herein may have the same meaning as commonly understood by one of ordinary skill in the art to which the present disclosure pertains. Among the terms used in the present disclosure, terms defined in a general dictionary may be interpreted as having the same or similar meaning as the meaning in the context of the related art, and are not interpreted in an idealized or excessively formal sense unless clearly defined in the present disclosure. In some cases, even terms defined in the present disclosure cannot be interpreted to exclude embodiments of the present disclosure.

In various embodiments of the present disclosure described below, a hardware approach is described as an example. However, since various embodiments of the present disclosure include technology using both hardware and software, various embodiments of the present disclosure do not exclude software-based approaches.

In addition, in the detailed description and claims of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

Hereinafter, the present disclosure relates to an apparatus and method for mobility-aware resource management based on a hierarchical Open-RAN architecture in a wireless communication system. Specifically, the present disclosure describes a technology for dynamically determining GoB (Grid of Beams) beam scheduling, user scheduling, transmission power, and bandwidth allocation by utilizing the hierarchical structure of an Open-RAN network and user mobility information in a wireless communication system.

Terms referring to signals, terms referring to channels, terms referring to control information, terms referring to network entities, and terms referring to components of an apparatus used in the following description are exemplified for convenience of explanation. Accordingly, the present disclosure is not limited to the terms described below, and other terms having equivalent technical meanings may be used.

In addition, the present disclosure describes various embodiments using terms used in some communication standards (e.g., 3rd Generation Partnership Project (3GPP)), but this is only an example for explanation. Various embodiments of the present disclosure can be easily modified and applied to other communication systems as well.

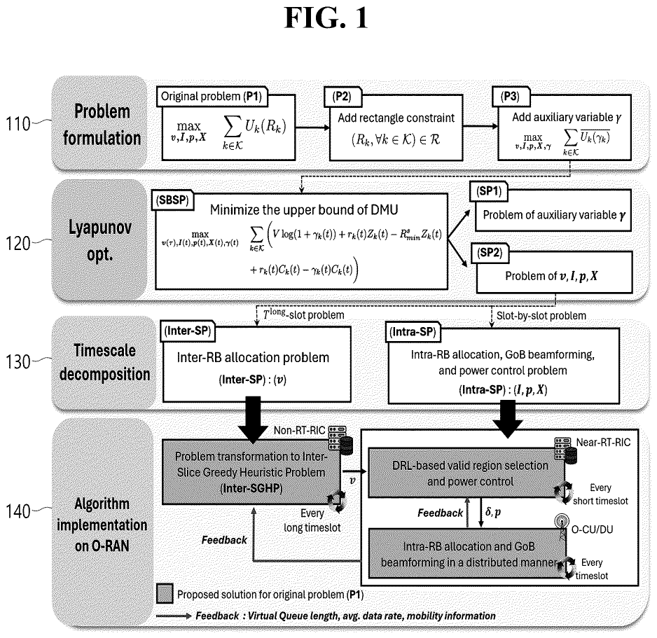

FIG. 1 illustrates the overall structure of a hierarchical Open-RAN architecture-based resource management system according to an embodiment of the present disclosure.

FIG. 1 illustrates the overall structure and algorithm processing process of a hierarchical Open-RAN architecture-based resource management system according to an embodiment of the present disclosure.

Referring to FIG. 1, the system of the present disclosure consists of four main stages: Problem formulation (110), Lyapunov optimization (120), Timescale decomposition (130), and Algorithm implementation on O-RAN (140).

In the problem definition stage (110), the original problem (P1) is first defined. In the present invention, GoB beam scheduling, user scheduling, transmission power, and bandwidth allocation are dynamically determined based on user mobility information, interference relationships, and channel conditions. To this end, the objective function of the problem to maximize the utility sum of data transmission rates over the entire time slots is defined as follows.

$${max}_{v , I , p , X} {\sum }_{k ∈ 𝒦} {U}_{k} ( {R}_{k} ) \qquad [ Equation l ]$$

Here, T represents the number of total time slots, K represents the entire user set, Uk(·) is the utility function of user k, generally defined in the form of log (1+x) to ensure proportional fairness. Rk(t) represents the data transmission rate of user k at time slot t. v is a bandwidth allocation vector, I is a user scheduling indicator matrix, p is a transmission power vector, and X is a GoB beam scheduling matrix.

The optimization problem of Equation 1 must satisfy the following constraints.

$$subject to {\sum }_{s ∈ 𝒮} {υ}^{s} ( τ ) \leq Q , τ ∈ {𝒯}^{long} \qquad [ Equation 2 ]$$

Here, υ⁸(τ) represents the bandwidth allocated to network slice s at time τ, S is the network slice set, Q is the total available bandwidth, and [symbol] represents the long time scale.

$${υ}^{s} ( τ ) \geq {Q}_{min} , ∀ s ∈ 𝒮 \qquad [ Equation 3 ]$$

Here, Qmin represents the minimum bandwidth requirement for each slice.

$${\sum }_{k ∈ 𝒦} {I}_{n , k}^{s} ( t ) \leq 1 , ∀ s ∈ 𝒮 , ∀ n ∈ 𝒩 , \qquad [ Equation 4 ]$$

Here,

$${I}_{n , k}^{s} ( t ) \leq 1$$

is a binary indicator that is 1 if base station n of slice s schedules user k at time slot t, and 0 otherwise, and N represents the base station set.

$${\sum }_{n ∈ 𝒩} {p}_{n}^{s} ( t ) \leq {P}^{s} , ∀ s ∈ 𝒮 , \qquad [ Equation 5 ]$$

Here,

$${p}_{n}^{s} ( t )$$

represents the transmission power of base station n of slice s at time slot t, and P\hat{ }s represents the maximum transmission power of slice s.

$${P}_{n , min}^{s} \leq {p}_{n}^{s} ( t ) \leq {P}_{n , max}^{s} , ∀ s ∈ 𝒮 , ∀ n ∈ 𝒩 \qquad [ Equation 6 ]$$

Here,

$${P}_{n , min}^{s} and {P}_{n , max}^{s}$$

represent the minimum and maximum transmission power of base station n of slice s, respectively.

$${\sum }_{b ∈ B} {X}_{n , b}^{s} ( t ) \leq 1 , ∀ s ∈ 𝒮 , ∀ n ∈ 𝒩 \qquad [ Equation 7 ]$$

Here,

$${\sum }_{b ϵ B} {X}_{n , b}^{s} ( t )$$

is a binary variable that is 1 if beam b of base station n of slice s is activated at time slot t, and 0 otherwise, and B represents the beam set.

$${R}_{k} \geq {R}_{min}^{s} , ∀ s ϵ 𝒮 , ∀ k ϵ {𝒦}^{s} \qquad [ Equation 8 ]$$

Here,

$${R}_{min}^{s}$$

represents the minimum data transmission rate required by users of slice s, and K^{s} represents the user set belonging to slice s.

This problem can be transformed into a time slot-by-time slot problem by utilizing the properties of Rectangular Constraint, Auxiliary Variable, and Jensen's Inequality. To solve this using Lyapunov optimization techniques, two types of virtual queues Z_k(t) and C_k(t) are defined as follows.

$${Z}_{k} ( t + 1 ) = {[ {Z}_{k} ( t ) + {R}_{min}^{s} - {r}_{k} ( t ) ]}^{+} , ∀ n ϵ 𝒩 , ∀ s ϵ 𝒮 , ∀ k ϵ {𝒦}_{s}^{n} \qquad [ Equation 9 ]$$

Here, Zk(t) is a virtual queue for satisfying the quality of service required for each user, rk(t) is the actual data transmission rate of user k at time slot t, and [·]⁺ represents the max [·, 0] operation.

$${C}_{k} ( t + 1 ) = {[ {C}_{k} ( t ) + {γ}_{k} ( t ) - {r}_{k} ( t ) ]}^{+} , ∀ k ϵ 𝒦 \qquad [ Equation 10 ]$$

Here, Ck(t) is a virtual queue related to fairness of data transmission rate, and γk(t) is an auxiliary variable that tracks the time-average data transmission rate of user k.

The present disclosure operates to satisfy the real-time objective function while stabilizing these two types of virtual queues. First, the Lyapunov function, Lyapunov drift function, and Lyapunov drift-minus-utility function are defined as follows.

$$L ( Q ( t ) ) = \frac{1}{2} \{ {\sum }_{n ϵ 𝒩} {\sum }_{s ϵ 𝒮} {\sum }_{k ϵ {𝒦}_{s}^{n}} {{Z}_{k} ( t )}^{2} + {\sum }_{k ϵ 𝒦} {{C}_{k} ( t )}^{2} \} \qquad [ Equation 11 ]$$

Here, Q(t) is a vector representing all virtual queue states at time slot t. The Lyapunov function is a scalar metric representing the queue backlog state of the system, and has a smaller value as all virtual queues approach 0.

$$Δ L ( Q ( t ) = \{ L ( Q ( t + 1 ) ) - L ( Q ( t ) \vert Q ( t ) \} \qquad [ Equation 12 ]$$

The Lyapunov drift represents the conditional expectation of the change in the Lyapunov function between consecutive time slots.

$$L ( Q ( t ) ) - V {\sum }_{k ϵ 𝒦} 𝔼 \{ log ( 1 + {γ}_{k} ( t ) ) \vert Q ( t ) \} \qquad [ Equation 13 ]$$

In the Lyapunov drift-minus-utility function, V is a positive control parameter that adjusts the trade-off between utility and queue stability. The larger V is, the greater weight is placed on utility maximization, and the smaller V is, the greater weight is placed on queue stability.

In Lyapunov optimization, by minimizing the upper bound of the above Lyapunov drift-minus-utility function at every time slot, the objective function of the original problem can be maximized while stabilizing the virtual queue to satisfy the constraints of this problem. Arranging the expression containing the auxiliary variable γₖ in the slot-by-slot problem gives the following.

$${max}_{γ ( t )} {\sum }_{k ϵ 𝒦} ( V log ( 1 + {γ}_{k} ( t ) ) - {γ}_{k} ( t ) {C}_{k} ( t ) ) \qquad [ Equation 14 ]$$

Since the objective function of this problem is a convex function, it can be easily solved through differentiation.

$${γ}_{k} ( t ) = {[ \frac{V}{{C}_{k} ( t )} - 1 ]}_{min}^{max} , ∀ k \qquad [ Equation 15 ]$$

Here,

$${[ \cdot ]}_{min}^{+}$$

represents an operation that guarantees a value above the minimum value.

The expressions related to bandwidth allocation (v), user scheduling (I), transmission power (p), and GoB beam scheduling (X), excluding the auxiliary variable γₖ, are arranged as follows.

### [Equation 16]

Here, rk(t) represents the achievable data transmission rate of user k according to the resource allocation decision.

The problem of Equation 16 is difficult to solve because it includes four coupled decision variables as a mixed-integer nonlinear problem. To solve this effectively, it is decomposed into an inter-slice problem that determines bandwidth according to time scale and an intra-slice problem that determines user scheduling, transmission power, and GoB beam scheduling.

$${max}_{υ ( τ )} {\sum }_{t ϵ [ τ , τ + T ]} {\sum }_{s ϵ 𝒮} ( {\sum }_{k ϵ {𝒦}^{s}} ( {r}_{k} ( t ) ( {Z}_{k} ( t ) + {C}_{k} ( t ) - {R}_{min}^{s} {Z}_{k} ( t ) ) ) \qquad [ Equation 17 ]$$

Equation 17 is an inter-slice problem that determines bandwidth allocation at a long time scale.

$${max}_{υ ( τ )} {\sum }_{t ϵ [ τ , τ + T ]} {\sum }_{s ϵ 𝒮} ( {\sum }_{k ϵ {𝒦}^{s}} ( {r}_{k} ( t ) ( {Z}_{k} ( t ) + {C}_{k} ( t ) - {R}_{min}^{s} {Z}_{k} ( t ) ) ) \qquad [ Equation 17 ]$$

Equation 18 is an intra-slice problem that determines user scheduling, transmission power, and GoB beam scheduling at a short time scale.

The result of the inter-slice problem is utilized in solving the intra-slice problem, and the result of the intra-slice problem is fed back to the inter-slice problem, forming a closed-loop control structure that continuously optimizes the overall goal.

However, the inter-slice problem is difficult to solve directly because it requires future channel information and decision values of the intra-slice problem. To overcome this, it is reconstructed as an inter-slice greedy heuristic problem that approaches greedily based on the current queue length and utilizes past spectral efficiency information.

$${max}_{I ( t ) , p ( t ) , X ( t )} {\sum }_{k ϵ {𝒦}^{s}} ( {r}_{k} ( t ) ( {Z}_{k} ( t ) + {C}_{k} ( t ) ) - {R}_{min}^{s} {Z}_{k} ( t ) ) \qquad [ Equation 19 ]$$

Here, θₖ(τ) represents the past average spectral efficiency of user k. This problem can be efficiently solved using an LP solver.

On the other hand, the intra-slice problem that needs to determine GoB beam scheduling, transmission power, and user scheduling is difficult to solve in polynomial time due to complex interference relationships and interactions between decision variables. To solve this, user mobility information provided by an external location information server is utilized to effectively solve the intra-slice problem.

After receiving region information to be scheduled from the Near-RT-RIC, the O-CU/DU measures the reference signal received power of each GoB beam for users within the valid region. Then, for each user, it determines the GoB beam tuple with the highest reference signal received power, and determines user scheduling and GoB beam scheduling by selecting the tuple that maximizes the following objective function.

$${max}_{υ ( τ )} {\sum }_{s ϵ 𝒮} ( {υ}^{s} ( τ ) {\sum }_{k ϵ {𝒦}^{s}} ( {\overline{θ}}_{k} ( τ ) ( {Z}_{k} ( τ ) + {C}_{k} ( τ ) ) ) - {\sum }_{k ϵ {𝒦}^{s}} {R}_{min}^{s} {Z}_{k} ( τ ) ) \qquad [ Equation 20 ]$$

Here, K^{s} represents the user set within the valid region.

Through this hierarchical structure and time scale decomposition, the present disclosure can solve complex optimization problems efficiently while satisfying real-time processing requirements, and ensures the scalability and practicality of the entire system by each layer performing optimization within its own time scale and information scope.

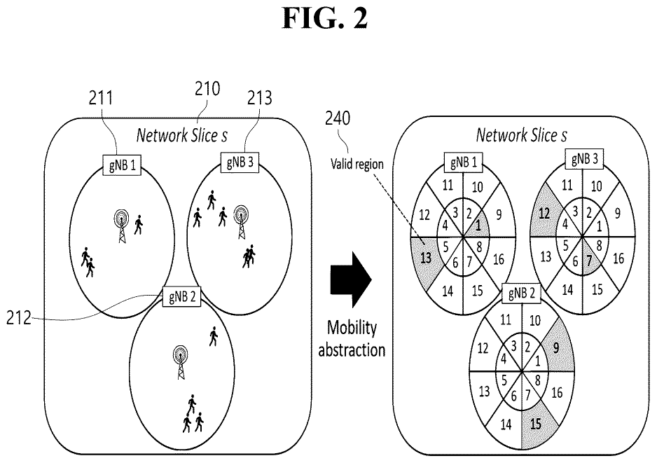

FIG. 2 illustrates an example of a valid region determination process through a region mapping module according to an embodiment of the present disclosure.

Referring to FIG. 2, the left box shows the situation where actual users are distributed within network slice s (210), and the right box shows the result converted to a valid region (240) through the mobility abstraction process.

Network slice s (210) consists of three base stations: gNB 1 (211), gNB 2 (212), and gNB 3 (213). Each base station provides services to users located within its coverage area. Users are indicated by black icons, and moving users are distinguished by red icons.

When the external location information server provides user mobility information at the Near-RT time scale, the Near-RT-RIC maps users to located regions using a region mapping module. In this process, the coverage area of each base station is divided into 16 detailed regions. gNB 1 (211) is divided into regions 1 through 16, and gNB 2 (212) and gNB 3 (213) are also divided into 16 regions each.

Among the mapped regions, regions where users are located or have a high possibility of movement are defined as valid regions (240). For example, region 7 is set as a valid region for gNB 1 (211), regions 9 and 15 are set as valid regions for gNB 2 (212), and region 7 is set as a valid region for gNB 3 (213).

The deep reinforcement learning agent of the Near-RT-RIC applies general deep reinforcement learning techniques to maximize the reward by setting the average data transmission rate, virtual queue information, and receivable interference of users within the valid region combination for each base station provided from the O-CU/DU layer as the state, and setting the objective function of Equation 18 as the reward during the Near-RT period. Through this, valid region selection and power to be allocated for each base station are determined as the action.

Through this region mapping and valid region setting, the O-CU/DU can perform scheduling operations considering only users within the valid region, and can effectively manage interference and optimize resources without depending on control variable determination of other base stations. In addition, computational complexity can be greatly reduced by scheduling only valid regions instead of scheduling the entire network at every time slot.

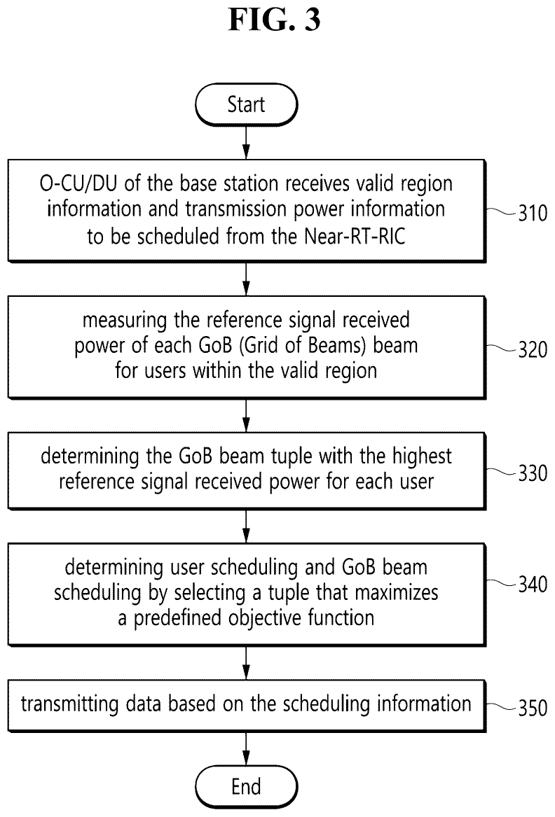

FIG. 3 is a flowchart illustrating an operation method of a base station (O-CU/DU) according to an embodiment of the present disclosure.

Referring to FIG. 3, the O-CU/DU of the base station performs the following process for hierarchical Open-RAN architecture-based resource management.

In step 310, the O-CU/DU of the base station receives valid region information and transmission power information to be scheduled from the Near-RT-RIC. The valid region information (scheduling target space subset identification information) is determined by the region mapping module of the Near-RT-RIC based on user mobility information provided from an external location information server as described in FIG. 2. This valid region information can be understood as information that identifies a spatial subset of the entire network coverage area where scheduling will actually be performed, through which the base station can improve interference management and resource efficiency by performing resource allocation only for users within a specific spatial region selectively. The transmission power information is determined by the deep reinforcement learning agent of the Near-RT-RIC to maximize the objective function of Equation 18. Along with this, the O-CU/DU can also receive bandwidth allocation information determined through solving the inter-slice problem from the Near-RT-RIC.

In step 320, the O-CU/DU measures the reference signal received power of each GoB (Grid of Beams) beam for users within the valid region. GoB is a technology that implements spatial multiplexing by dividing the coverage area of a base station into multiple beams, and may include a pre-defined codebook-based beamforming method. That is, GoB beams mean a method of covering the spatial domain in a grid form using a beam pattern selected from a pre-designed beam direction codebook, and this codebook-based approach enables effective spatial multiplexing while reducing the complexity of beam selection and scheduling. The O-CU/DU measures the Reference Signal Received Power (RSRP) of all available GoB beams for each user located within the valid region. At this time, since the measurement is performed only for users within the valid region, the computational complexity is greatly reduced compared to targeting all users in the entire network.

In step 330, the O-CU/DU determines the GoB beam tuple with the highest reference signal received power for each user. For each user, the measured RSRP values are compared to select the GoB beam with the highest value. At this time, the optimal beam tuple is determined by considering interference relationships and channel conditions together. One user can be allocated to at most one beam, and one beam can be allocated to only one user at the same time, satisfying these constraints.

In step 340, the O-CU/DU determines user scheduling and GoB beam scheduling by selecting a tuple that maximizes a predefined objective function. The objective function is defined as in Equation 20, and considers the virtual queue length for each user (Zₖ(t)+Cₖ(t)) and the utility of the data transmission rate (rₖ(t)). This is to maximize the data transmission rate while satisfying the quality of service requirements. The O-CU/DU finally determines user scheduling and GoB beam scheduling by selecting the user-beam allocation combination that maximizes this objective function.

According to one embodiment, the O-CU/DU may further include a process of calculating and transmitting average data transmission rate information and virtual queue information of users within the valid region combination for each base station to the Near-RT-RIC after step 340. This information is utilized by the deep reinforcement learning agent of the Near-RT-RIC to determine valid region selection and transmission power at the next time scale.

According to another embodiment, the O-CU/DU can manage interference without depending on control variable determination of other base stations by performing scheduling operations considering only users within the valid region. This is possible because the Near-RT-RIC pre-adjusts valid regions to minimize interference between base stations.

In step 350, the O-CU/DU transmits data based on the scheduling information. Actual data transmission is performed utilizing the determined user scheduling, GoB beam scheduling, and transmission power information received from the Near-RT-RIC. The transmission rate of the transmitted data is fed back to the objective function calculation and reflected in the scheduling decision of the next time slot.

This process is repeatedly performed at every time slot, and virtual queue information and average data transmission rate information are continuously updated and fed back to the Near-RT-RIC. Through this, the entire system can adaptively respond to dynamically changing channel environments and user mobility.

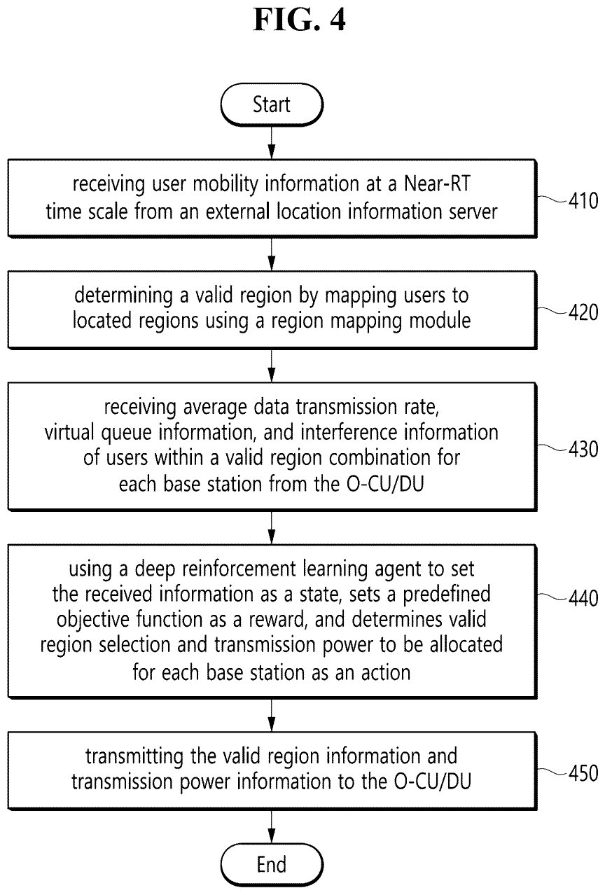

FIG. 4 is a flowchart illustrating an operation method of a Near-RT-RIC according to an embodiment of the present disclosure.

Referring to FIG. 4, the Near-RT-RIC performs the following process for hierarchical Open-RAN architecture-based resource management.

In step 410, the Near-RT-RIC receives user mobility information at a Near-RT time scale from an external location information server. The external location information server provides user location information and movement patterns collected through various methods such as GPS, base station triangulation, and WiFi-based location estimation to the Near-RT-RIC. The Near-RT time scale generally has a cycle between 10 ms and 1 second, which is an appropriate time interval that can track user mobility in real-time while preventing excessive signaling overhead.

User mobility information may include each user's location, movement speed, movement direction, etc. This user mobility-related information can be transmitted through the A1 interface (A1-EI, A1 Enrichment Information), and types such as UE location (terminal location), Region ID (region identifier), and mobility vector (movement vector) can be defined. Type information related to UE Mobility transmitted in A1-EI is associated with the Region Mapping Module of the present invention, and is utilized to map users to specific regions and determine valid regions.

In step 420, the Near-RT-RIC determines a valid region by mapping users to located regions using a region mapping module. As described in FIG. 2, the coverage area of each base station is divided into a predefined number of detailed regions, and valid regions are selected based on the user's current location and predicted movement path. According to one embodiment, the region mapping module can learn the user's past movement patterns to predict future locations, and include regions on the predicted path as valid regions. According to another embodiment, the region mapping module can dynamically adjust the size of the valid region considering the user's movement speed and direction.

In step 430, the Near-RT-RIC receives average data transmission rate, virtual queue information, and interference information of users within a valid region combination for each base station from the O-CU/DU. The average data transmission rate is the time average value of the actual data transmission rate achieved by each user, and the virtual queue information is an indicator representing whether the quality of service requirements defined in Equations 9 and 10 are satisfied. These performance indicators can be reported through the O1 interface (O1 PM, O1 Performance Management). In particular, as related indicators for Lyapunov optimization and virtual queue stabilization, Fairness queue (fairness queue) information, QoS queue (quality of service queue) information, Average data rate for each user (average data transmission rate for each user), etc. can be defined and reported through O1 PM, which is utilized by the DRL agent of the Near-RT-RIC to make optimal resource allocation decisions.

In step 440, the Near-RT-RIC uses a deep reinforcement learning agent to set the received information as a state, sets a predefined objective function as a reward, and determines valid region selection and transmission power to be allocated for each base station as an action. The state space of the deep reinforcement learning agent consists of the average data transmission rate of users within the valid region combination for each base station, virtual queue information (Z_k(t), C_k(t)), and interference information. The reward function is defined as the objective function of the intra-slice problem in Equation 18, and is trained to maximize the cumulative reward during the Near-RT time.

According to one embodiment, the deep reinforcement learning agent may use algorithms such as DON (Deep Q-Network), PPO (Proximal Policy Optimization), or SAC (Soft Actor-Critic). The agent is pre-trained through offline learning and continues to learn during online operation to adapt to network environment changes.

According to another embodiment, the Near-RT-RIC may further include a process of receiving bandwidth allocation information determined through solving the inter-slice problem from the Non-RT-RIC. The Non-RT-RIC operates at a longer time scale (e.g., minutes), and allocates bandwidth for each slice by solving the inter-slice greedy heuristic problem of Equation 19. This bandwidth allocation information acts as a constraint on the resource management decisions of the Near-RT-RIC.

According to yet another embodiment, the Near-RT-RIC can optimize resources from a network-wide perspective by utilizing all user information. This is in contrast to the O-CU/DU utilizing only user information within the base station, and enables inter-base station cooperation and interference management. The Near-RT-RIC collects and analyzes information from all base stations within the network slice, and determines valid regions and transmission power from a global optimization perspective.

According to one embodiment, the Near-RT-RIC can coordinate COMP (Coordinated Multi-Point) transmission among multiple base stations. When a user is located in a cell boundary region, the Near-RT-RIC adjusts the valid region and transmission power so that multiple adjacent base stations cooperate to provide service to that user.

In step 450, the Near-RT-RIC transmits the valid region information and transmission power information to the O-CU/DU. This information is the information that the O-CU/DU receives in step 310, and is utilized in the O-CU/DU's user scheduling and GoB beam scheduling decisions. Transmission can be performed through the E2 interface, which is an Open-RAN standard interface. Specifically, the valid region information (Valid Region selection result) and transmission power indication transmitted by the Near-RT-RIC can be implemented through parameter extension based on E2SM-RC (E2 Service Model—RAN Control), E2SM-LLC (E2 Service Model—Low-Layer Control), or E2SM-CCC (E2 Service Model—Cell and Connection Control) or through a custom service model. For example, the DRL (Deep Reinforcement Learning) inference result can be mapped and transmitted as an E2 Control Action based on E2SM-RC, through which power control elements (IE, Information Element) for each cell within the valid region can be set.

This process is repeatedly performed at every Near-RT time scale, and the deep reinforcement learning agent continuously learns to improve performance. Information received from the O-CU/DU through a feedback loop is reflected in the decision of the next time scale, allowing the system to adaptively respond to dynamic network environments.

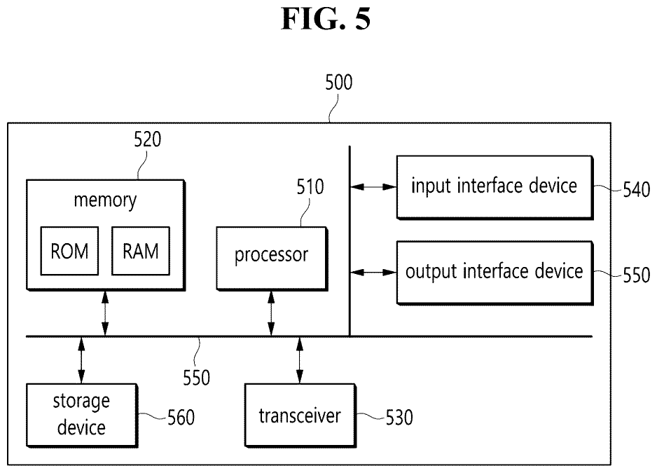

FIG. 5 illustrates the configuration of a wireless communication apparatus according to an embodiment of the present disclosure. The wireless communication apparatus 500 of FIG. 5 may be included in a base station or Near-RT-RIC to perform embodiments of the present disclosure.

Referring to FIG. 5, the wireless communication apparatus 500 may include at least one processor 510, a memory 520, and a transceiver 530 connected to a network to perform communication. In addition, the wireless communication apparatus 500 may further include an input interface device 540, an output interface device 550, a storage device 560, and the like. Each component included in the wireless communication apparatus 500 may be connected by a bus 570 to communicate with each other.

However, each component included in the wireless communication apparatus 500 may be connected through individual interfaces or individual buses centered on the processor 510, rather than the common bus 570. For example, the processor 510 may be connected to at least one of the memory 520, the transceiver 530, the input interface device 540, the output interface device 550, and the storage device 560 through a dedicated interface.

The processor 510 may execute program instructions stored in at least one of the memory 520 and the storage device 560. The processor 510 may refer to a central processing unit (CPU), a graphics processing unit (GPU), or a dedicated processor on which methods according to embodiments of the present invention are performed. Each of the memory 520 and the storage device 560 may be composed of at least one of a volatile storage medium and a non-volatile storage medium. For example, the memory 520 may be composed of at least one of a read only memory (ROM) and a random access memory (RAM).

When the wireless communication apparatus 500 is included in a base station, the processor 510 is configured to receive valid region information and transmission power information to be scheduled from a Near-RT-RIC, measure reference signal received power of each GoB beam for users within the valid region, determine a GoB beam tuple having the highest reference signal received power for each user, determine user scheduling and GoB beam scheduling by selecting a tuple that maximizes a predefined objective function, and transmit data based on the determined scheduling information.

When the wireless communication apparatus 500 is included in a Near-RT-RIC, the processor 510 is configured to receive user mobility information at a Near-RT time scale from an external location information server, determine a valid region (scheduling target space subset) by mapping users to located regions using a region mapping module, receive average data transmission rate, virtual queue information, and interference information of users within a valid region combination for each base station from the O-CU/DU, use a deep reinforcement learning agent to set the received information as a state and set a predefined objective function as a reward to determine valid region selection and transmission power to be allocated for each base station as an action, and transmit the determined valid region information and transmission power information to the O-CU/DU.

Methods according to embodiments described in the claims or specification of the present disclosure may be implemented in the form of hardware, software, or a combination of hardware and software.

When implemented as software, a computer-readable storage medium storing one or more programs (software modules) may be provided. One or more programs stored in the computer-readable storage medium are configured for execution by one or more processors within an electronic device. The one or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, or magnetic cassettes. Alternatively, they may be stored in a memory composed of a combination of some or all of these. In addition, each constituent memory may be included in plurality.

In addition, the program may be stored in an attachable storage device that can be accessed through a communication network such as the Internet, Intranet, local area network (LAN), wide area network (WAN), or storage area network (SAN), or a communication network composed of a combination thereof. Such a storage device may be connected to a device performing embodiments of the present disclosure through an external port. In addition, a separate storage device on the communication network may be connected to a device performing embodiments of the present disclosure.

In the specific embodiments of the present disclosure described above, components included in the disclosure are expressed in singular or plural forms according to the specific embodiments presented. However, the singular or plural expressions are selected appropriately for the situation presented for convenience of explanation, and the present disclosure is not limited to singular or plural components, and even components expressed in plural may be composed of singular, or components expressed in singular may be composed of plural.

Meanwhile, although specific embodiments have been described in the detailed description of the present disclosure, various modifications are possible without departing from the scope of the present disclosure. Therefore, the scope of the present disclosure should not be limited to the described embodiments and should be determined not only by the scope of the claims described below but also by equivalents to the scope of the claims.

What is claimed is:

1. An operation method of a base station for hierarchical Open-RAN architecture-based resource management in a wireless communication system, the method comprising:
receiving, by an (Open-Centralized O-CU/DU Unit/Distributed Unit) of the base station, valid region information and transmission power information to be scheduled from a Near-RT-RIC (Near Real-Time RAN Intelligent Controller);
measuring reference signal received power of each GoB (Grid of Beams) beam for users within the valid region;
determining, for each user, a GoB beam tuple having the highest reference signal received power;
determining user scheduling and GoB beam scheduling by selecting a tuple that maximizes a predefined objective function; and
transmitting data based on the scheduling information.

2. The method of claim 1, further comprising transmitting, by the O-CU/DU, average data transmission rate information and virtual queue information of users within a valid region combination for each base station to the Near-RT-RIC.

3. The method of claim 1, wherein the predefined objective function is defined by considering a virtual queue length for each user and a utility of a data transmission rate.

4. The method of claim 1, wherein the valid region is determined by the Near-RT-RIC through a region mapping module based on user mobility information provided from an external location information server.

5. The method of claim 1, wherein the O-CU/DU manages interference without depending on control variable determination of other base stations by performing a scheduling operation considering only users within a valid region.

6. An operation method of a Near-RT-RIC for hierarchical Open-RAN architecture-based resource management in a wireless communication system, the method comprising:
receiving user mobility information at a Near-RT time scale from an external location information server;
determining a valid region by mapping users to located regions using a region mapping module;
receiving, from an O-CU/DU, average data transmission rate, virtual queue information, and interference information of users within a valid region combination for each base station;
determining, using a deep reinforcement learning agent, valid region selection and transmission power to be allocated for each base station as an action by setting the received information as a state and setting a predefined objective function as a reward; and
transmitting the valid region information and the transmission power information to the O-CU/DU.

7. The method of claim 6, wherein the predefined objective function is an objective function of an intra-slice problem that is a function for determining GoB (Grid of Beams) beam scheduling, transmission power, and user scheduling.

8. The method of claim 6, wherein the deep reinforcement learning agent is trained to maximize a reward during the Near-RT time.

9. The method of claim 6, further comprising receiving bandwidth allocation information determined through solving an inter-slice problem from a Non-RT-RIC.

10. The method of claim 6, wherein the Near-RT-RIC optimizes resources from a network-wide perspective by utilizing information of all users.

11. A base station for hierarchical Open-RAN architecture-based resource management in a wireless communication system, the base station comprising: a transceiver; and a processor operably connected to the transceiver, wherein the processor is configured to:
receive valid region information and transmission power information to be scheduled from a Near-RT-RIC (Near Real-Time RAN Intelligent Controller), measure reference signal received power of each GoB (Grid of Beams) beam for users within the valid region, determine, for each user, a GoB beam tuple having the highest reference signal received power, determine user scheduling and GoB beam scheduling by selecting a tuple that maximizes a predefined objective function, and transmit data based on the scheduling information.

12. The base station of claim 11, wherein the processor is further configured to transmit average data transmission rate information and virtual queue information of users within a valid region combination for each base station to the Near-RT-RIC.

13. The base station of claim 11, wherein the predefined objective function is defined by considering a virtual queue length for each user and a utility of a data transmission rate.

14. The base station of claim 11, wherein the processor is configured to manage interference without depending on control variable determination of other base stations by performing a scheduling operation considering only users within a valid region.

15. The base station of claim 11, wherein the base station includes an O-CU/DU (Open-Centralized Unit/Distributed Unit), and the O-CU/DU is configured to optimize resources by utilizing only user information within the base station.
